(19) United States
(12) Patent Application Publication
(10) Pub. No.: US 2025/0271865 A1
(43) Pub. Date: Aug. 28, 2025

(54) PICKING ROBOT CONTROL METHOD AND APPARATUS, ELECTRONIC DEVICE, AND STORAGE MEDIUM

(71) Applicant: Beijing Youzhuju Network Technology Co., Ltd., Beijing (CN)

(72) Inventors: Linge ZHANG, Beijing (CN); Yin YIN, Beijing (CN)

(21) Appl. No.: 19/033,452

(22) Filed: Jan. 21, 2025

(30) Foreign Application Priority Data
Feb. 27, 2024 (CN) 202410218541.5

(51) Int. Cl. G05D 1/644; B65G 1/137; G05D 1/622; G05D 105/28

(52) U.S. Cl. CPC G05D 1/644; B65G 1/1373; G05D 1/622; G05D 2105/28

(57) ABSTRACT

A picking robot control method and apparatus, an electronic device, and a storage medium. The method includes: in response to receiving a plurality of picking tasks by a picking robot, determining, based on the plurality of picking tasks, at least two candidate passage paths for the picking robot to move between a plurality of shelves in a warehouse; determining, based on a passage influencing factor corresponding to each of the candidate passage paths, a path passage efficiency corresponding to the candidate passage path; and determining a picking passage path from a plurality of the candidate passage paths based on the path passage efficiency, and controlling the picking robot to move along the picking passage path to transport an item to be picked.

The present disclosure claims priority of Chinese Patent Application No. 202410218541.5 filed on Feb. 27, 2024, the entire disclosure of which is incorporated by reference in the present disclosure.

### TECHNICAL FIELD

Embodiments of the present disclosure relate to a picking robot control method and apparatus, an electronic device, and a storage medium.

### BACKGROUND

With the development of warehouse management technologies, in some warehouses, a picking order is sent to a delivery robot, which then walks in a warehouse to pick goods according to the picking order. In response to receiving a large number of picking orders or in the case of a limited number of delivery robots, one of the delivery robots may be assigned a plurality of picking orders, and different picking orders may correspond to different picking locations. In this case, it is particularly important to plan a high-efficiency picking passage path for the delivery robot.

In the related art, when a delivery robot handles a plurality of picking orders, one way is to determine a picking passage path based on a receiving time of each picking order. This way may make a walking path of the delivery robot longer, thus resulting in a lower picking efficiency. Another way is to plan the shortest picking passage path based on the plurality of picking orders. However, due to a complex and changing environment in a warehouse, it is difficult to stably implement high-efficiency picking by determining an optimal path using only the distance.

### SUMMARY

The present disclosure provides a picking robot control method and apparatus, an electronic device, and a storage medium, to achieve an effect of determining an optimal picking path on the basis of comprehensive consideration of a picking task and a passage influencing factor, thus achieving an effect of ensuring high-efficiency picking by using the optimal picking path.

According to a first aspect, an embodiment of the present disclosure provides a picking robot control method. The method includes:
in response to receiving a plurality of picking tasks by a picking robot, determining, based on the plurality of picking tasks, at least two candidate passage paths for the picking robot to move between a plurality of shelves in a warehouse;
determining, based on a passage influencing factor corresponding to each of the candidate passage paths, a path passage efficiency corresponding to the candidate passage path, where the passage influencing factor includes at least one of road layout information in the warehouse, road passage information in the warehouse, and a collaboration influencing factor with relative to a picker in the warehouse; and
determining a picking passage path from a plurality of the candidate passage paths based on the path passage efficiency, and controlling the picking robot to move along the picking passage path to transport an item to be picked.

According to a second aspect, an embodiment of the present disclosure further provides a picking robot control apparatus. The apparatus includes:
a candidate path determination module, configured to, in response to receiving a plurality of picking tasks by a picking robot, determine, based on the plurality of picking tasks, at least two candidate passage paths for the picking robot to move between a plurality of shelves in a warehouse;
a passage efficiency determination module, configured to determine, based on a passage influencing factor corresponding to each of the candidate passage paths, a path passage efficiency corresponding to the candidate passage path, where the passage influencing factor includes at least one of road layout information in the warehouse, road passage information in the warehouse, and a collaboration influencing factor with relative to a picker in the warehouse; and
a robot control module, configured to determine a picking passage path from a plurality of the candidate passage paths based on the path passage efficiency, and control the picking robot to move along the picking passage path to transport an item to be picked.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the picking robot control method according to any one of the embodiments of the present disclosure.

According to a fourth aspect, an embodiment of the present disclosure further provides a non-transient computer-readable storage medium including computer-executable instructions, where the computer-executable instructions, when executed by a computer processor, are configured to perform the picking robot control method according to any one of the embodiments of the present disclosure.

According to a fifth aspect, an embodiment of the present disclosure further provides a computer program product including a computer program that, when executed by a processor, causes the processor to implement the picking robot control method according to any one of the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a picking robot control method according to an embodiment of the present disclosure;

FIG. 2 is a schematic flowchart of another picking robot control method according to an embodiment of the present disclosure;

FIG. 3 is a schematic diagram of a structure of a picking robot control apparatus according to an embodiment of the present disclosure; and

FIG. 4 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before the technical solutions are described, an exemplary description of an application scenario may be given. The technical solutions may be applied to any scenario where a picking task needs to be performed in a target region. For ease of description of the technical solutions in the embodiments of the present disclosure, the technical solutions in the embodiments of the present disclosure may be described by taking a warehousing scenario as an example. For example, in the warehousing scenario, a picking order may be sent to a delivery robot, which then walks in a warehouse to pick goods according to the picking order. In response to receiving a large number of picking orders in the warehouse or in the case of a limited number of delivery robots, one of the delivery robots may need to handle a plurality of picking orders that may be located at different picking locations. In the related art, when a delivery robot handles a plurality of picking orders, one way is to determine a picking passage path based on a receiving time of each picking order. This way may make a walking path of the delivery robot longer, thus resulting in a lower picking efficiency. Another way is to plan the shortest picking passage path based on the plurality of picking orders. However, due to a complex and changing environment in a warehouse, it is difficult to stably implement high-efficiency picking by determining an optimal path using only the distance.

In this case, based on the technical solutions in the embodiments of the present disclosure, when a delivery robot receives a plurality of picking tasks, at least two candidate passage paths for the picking robot to move between a plurality of shelves in a warehouse are first determined based on the plurality of picking tasks. Then, for each candidate passage path, a passage influencing factor corresponding to the candidate passage path is determined, and a path passage efficiency corresponding to the candidate passage path is determined based on the passage influencing factor. Further, a picking passage path may be determined from a plurality of candidate passage paths based on the path passage efficiency corresponding to each candidate passage path. Then, the delivery robot may be controlled to move along the picking passage path to deliver an item to be picked. Therefore, an effect of determining an optimal picking path on the basis of comprehensive consideration of the picking tasks and the passage influencing factor is achieved, and an effect of ensuring high-efficiency picking by using the optimal picking path is achieved.

FIG. 1 is a schematic flowchart of a picking robot control method according to an embodiment of the present disclosure. This embodiment of the present disclosure is applicable to a case where an optimal picking path is determined and a picking robot is controlled to perform a picking task according to the optimal picking path. The method may be performed by a picking robot control apparatus, and the apparatus may be implemented in the form of software and/or hardware. Optionally, the apparatus may be implemented by an electronic device, which may be a mobile terminal, a PC, a server, etc.

As shown in FIG. 1, the method in this embodiment may specifically include the following steps.

S110: In response to receiving a plurality of picking tasks by a picking robot, determining, based on the plurality of picking tasks, at least two candidate passage paths for the picking robot to move between a plurality of shelves in a warehouse.

The picking robot includes at least one item storage container for holding an item to be picked that corresponds to the picking task. The picking robot moves between the plurality of shelves in the warehouse to transport the item. The shelf includes a plurality of goods storage compartments for separate storage of different items. The picking task may be a task of picking a corresponding item from the shelf and transporting the item to a target location. Generally, when receiving a picking task, the picking robot may determine an item to be picked that corresponds to the picking task, a storage location of the item to be picked on a shelf, and a target location to which the item to be picked is to be transported. Further, a picking path may be determined based on the storage location, a current location of the picking robot, and the target location. Then, the picking robot may be controlled to move according to the determined picking path to transport the item to be picked to the target location. As such, the picking task is completed. In this embodiment of the present disclosure, in order to improve the picking efficiency, the picking robot may receive a plurality of picking tasks, and may transport, at a time, items to be picked that correspond to the plurality of picking tasks upon receiving the plurality of picking tasks. The candidate passage path may be understood as a path that enables the picking robot to move between the plurality of shelves in the warehouse to transport the items to be picked. The candidate passage path may be a passage path among a plurality of initial passage paths that meets a preset picking criterion. Optionally, the preset picking criterion may be a high picking efficiency, a short picking time, etc.

In this embodiment of the present disclosure, when the picking robot receives the plurality of picking tasks, a plurality of picking paths may be determined based on storage locations of the items to be picked on the shelves in the plurality of picking tasks and shelf layout information in the warehouse. Further, in order to improve the picking efficiency, at least two paths may be determined from the plurality of picking paths according to a preset screening criterion, and the at least two determined paths may be used as the candidate passage paths. Optionally, the preset screening criterion may be a path length-based screening criterion, etc.

Optionally, the determining, based on the plurality of picking tasks, at least two candidate passage paths for the picking robot to move between a plurality of shelves in a warehouse includes: determining a plurality of target picking points corresponding to the plurality of picking tasks, and determining a plurality of initial passage paths based on the plurality of target picking points and road layout information in the warehouse; and determining the at least two candidate passage paths from the plurality of initial passage paths according to an ascending sort of lengths of the initial passage paths.

The target picking point may be a point on a shelf at which an item to be picked is stored, that is, a location of a goods storage compartment where the item to be picked is stored. Alternatively, the target picking point may be a temporary storage point for the item to be picked, that is, a location where the item to be picked is taken out of the shelf and then temporarily stored to wait for the picking robot. The road layout information may be used to characterize a layout of roads in the warehouse. It can be understood that in addition to the plurality of shelves, there are also roads that lead to the shelves in the warehouse. Moreover, in order to improve the storage utilization of the warehouse and the execution efficiency of picking tasks, the shelves and roads in the warehouse may be laid out, and road information obtained after the layout may be used as the road layout information. The initial passage path may be a passage path that includes a plurality of target picking points and conforms to the road layout information. In this embodiment of the present disclosure, when the picking robot receives the plurality of picking tasks, for each picking task, a target picking point corresponding to the picking task may be determined based on an item to be picked that corresponds to the picking task. Then, a plurality of target picking points corresponding to the plurality of picking tasks may be determined. Further, the road layout information in the warehouse may be obtained, and a plurality of passage paths that can cover the plurality of target picking points may be determined based on the plurality of target picking points and the road layout information, and the determined passage paths may be used as the initial passage paths.

The length of the initial passage path may be a sum of lengths of sections that are passed through from a start point of the path to an end point of the path. The length of the initial passage path may be determined in a variety of manners, optionally by means of Manhattan distance, that is, by determining a Manhattan distance between the start point of the path and the end point of the path. Those skilled in the art will appreciate that the Manhattan distance, also known as city block distance or LI distance, is a sum of vertical and horizontal distances between two points. In this embodiment of the present disclosure, a grid map may be built based on the road layout information and the shelf layout information in the warehouse, and the picking points may be used as grids in the grid map. Further, when the plurality of target picking points are determined, point coordinates of each target picking point in the grid map may be determined. Then, after the plurality of initial passage paths are obtained, for each initial passage path, a Manhattan distance for the initial passage path may be determined based on the point coordinates corresponding to each target picking point, and the obtained Manhattan distance may be used as the length of the initial passage path.

As an optional implementation of this embodiment of the present disclosure, when the picking robot receives the plurality of picking tasks, the target picking points corresponding to the plurality of picking tasks may be determined based on the plurality of picking tasks. Further, the plurality of initial passage paths may be determined based on the target picking points and the road layout information in the warehouse. Then, the length of each initial passage path may be determined, and the plurality of initial passage paths may be sorted in ascending order of their lengths. Further, the at least two candidate passage paths may be determined from the plurality of sorted initial passage paths. Such a setting is beneficial in achieving an effect of planning the plurality of initial paths based on the plurality of picking orders, and determining the candidate passage paths based on the lengths of the initial paths, and thus achieving an effect of obtaining the passage paths through preliminary screening based on the path lengths, thereby ensuring that an ultimately determined picking path has a path length that is within a relatively short range.

In this embodiment of the present disclosure, there may be a plurality of manners to determine the at least two candidate passage paths from the plurality of sorted initial passage paths. Each determination manner will be described below.

In a first determination manner, a preset number of initial passage paths are selected starting from the first-ranked initial passage path, and the selected initial passage paths are used as the candidate passage paths.

For example, assuming that the preset number is two, after the plurality of sorted initial passage paths are obtained, the top two initial passage paths may be used as the candidate passage paths.

In a second determination manner, for each of the sorted initial passage paths, a length difference between the initial passage path and the first-ranked initial passage path is determined, to obtain a plurality of length differences. Initial passage paths for which the length difference is not greater than a first preset value are used as the candidate passage paths.

For example, assuming that there may be five initial passage paths, the sorted initial passage paths are respectively a path 1 (28 meters), a path 2 (25 meters), a path 3 (30 meters), a path 4 (31 meters), and a path 5 (45 meters). Further, using the length corresponding to the shortest path 2 as a reference length, the path 1 has a length difference of 3 meters from the reference length, the path 2 has a length difference of 0 meter from the reference length, the path 3 has a length difference of 5 meters from the reference length, the path 4 has a length difference of 6 meters from the reference length, and the path 5corresponds to a length difference of 20 meters. Assuming that the first preset value is 5 meters, it may be determined, by comparing each length difference with the first preset value, that initial passage paths for which the length difference is not greater than the first preset value may be the path 1, the path 2, and the path 3. Then, the path 1, the path 2, and the path 3 may be used as the candidate passage paths.

In a third determination manner, initial passage paths having a length not greater than a second preset value are determined from the plurality of initial passage paths, and the determined initial passage paths are used as the candidate passage paths.

For example, assuming that the second preset value is 35 meters, with continued reference to the above example, initial passage paths having a length not greater than the second preset value among the five initial passage paths may be the path 1, the path 2, the path 3, and the path 4. Then, the path 1, the path 2, the path 3, and the path 4 may be used as the candidate passage paths.

S120: Determining, based on a passage influencing factor corresponding to each of the candidate passage paths, a path passage efficiency corresponding to the candidate passage path.

The passage influencing factor includes at least one of road layout information in the warehouse, road passage information in the warehouse, and a collaboration influencing factor with relative to a picker in the warehouse. The passage influencing factor may be understood as a factor that influences the path passage efficiency or a path passage time. The passage influencing factor may include a positive influencing factor and a negative influencing factor. The positive influencing factor may be a factor that can improve the path passage efficiency or reduce the path passage time. The negative influencing factor may be a factor that can reduce the path passage efficiency or increase the path passage time. The road passage information may be understood as information that can characterize a road passage condition. The road passage information may be used to indicate object types and/or a total number of road passage objects that are allowed to pass through a corresponding road, and road passage objects that are not allowed to pass through the road. The road passage information may include at least object types and/or a total number of road passage objects included in the candidate passage path within a preset time period. The road passage object may include the picking robot and/or an item transport vehicle, such as a forklift. The collaboration influencing factor with relative to the picker may be used to characterize a condition of coordination and cooperation between the picker and the picking robot. Generally, when the picking robot is used to perform a picking task, the picking robot may need support from a picker and cooperate with the picker to complete the picking task. For example, when the picking robot moves to a target picking point corresponding to the picking task, the picking robot itself may not be able to store an item to be picked in a corresponding item storage container. Then, the picking robot may wait for the picker to store the item to be picked in the picking robot. The collaboration influencing factor may include at least collaboration distance information, where the collaboration distance information is the shortest distance that a picker closest to the candidate passage path in the warehouse moves to the candidate passage path.

In this embodiment of the present disclosure, for each candidate passage path, an initial passage time corresponding to the candidate passage path may be determined based on the length of the candidate passage path and an average passage speed of the picking robot. Further, the passage influencing factor corresponding to the candidate passage path may be determined based on the road layout information, the road passage information, and picker locating information in the warehouse. Then, the path passage efficiency corresponding to the candidate passage path may be determined based on the passage influencing factor and the initial passage time corresponding to the candidate passage path. The path passage efficiency may be understood as a ratio of a task volume of the plurality of picking tasks to a time taken to complete the plurality of picking tasks.

It should be noted that the candidate passage path may be composed of a plurality of passage sections, and each passage section may correspond to the same or different passage influencing factors. Therefore, for determination of the passage influencing efficiency corresponding to each candidate passage path, the candidate passage path is divided into at least two candidate passage sections, and a passage influencing factor corresponding to each candidate passage section is determined. Further, for each candidate passage section, a section passage efficiency corresponding to the candidate passage section may be determined based on the passage influencing factor corresponding to the candidate passage section. Then, the path passage efficiency corresponding to the candidate passage path may be determined based on section passage efficiencies corresponding to the plurality of candidate passage sections.

It should also be noted that for each candidate passage section, the passage influencing factor corresponding to the candidate passage section may include one or more of the road layout information, the road passage information, and the collaboration influencing factor with relative to the picker in the warehouse.

Optionally, when the passage influencing factor corresponding to the candidate passage section includes one passage influencing factor, the section passage efficiency corresponding to the candidate passage section may be determined based on the one passage influencing factor.

Optionally, when the passage influencing factor corresponding to the candidate passage section includes a plurality of passage influencing factors, an influencing parameter corresponding to each passage influencing factor may be determined. Further, the section passage efficiency corresponding to the candidate passage section may be determined based on each passage influencing factor and the corresponding influencing parameter.

S130: Determining a picking passage path from the plurality of candidate passage paths based on the path passage efficiency, and controlling the picking robot to move along the picking passage path to transport an item to be picked.

The picking passage path is a travel path of the picking robot when performing the plurality of received picking tasks.

In this embodiment of the present disclosure, after the path passage efficiency corresponding to each candidate passage path is determined, the highest efficiency may be determined from the plurality of path passage efficiencies, and a candidate passage path corresponding to the highest efficiency may be used as the picking passage path. Further, the picking robot may be controlled to move along the picking passage path to the target picking point corresponding to the picking task, and put the item to be picked that is stored in the target picking point in the corresponding item storage container of the picking robot. As such, a transport process of the item to be picked may be completed.

It should be noted that during the process of controlling the picking robot to move along the picking passage path, there may be an obstacle that hinders the movement of the picking robot in the picking passage path that the picking robot is to pass through. For this situation, in the related art, the picking robot may continue moving along the picking passage path even when the obstacle is detected, and consequently the robot may get stuck.

In view of this, in the embodiment of the present disclosure, after the controlling the picking robot to move along the picking passage path, the method further includes: when there is an obstacle in the picking passage path that hinders the movement of the picking robot, controlling the picking robot according to a preset obstacle avoidance strategy.

The preset obstacle avoidance strategy includes: waiting to pass until the obstacle has been removed, or updating the picking passage path and moving along the updated picking passage path.

It should be noted that the preset obstacle avoidance strategy of waiting to pass until the obstacle has been removed may indicate that the obstacle in the picking passage path is an obstacle that can be removed in a short time; and the preset obstacle avoidance strategy of updating the picking passage path and moving along the updated picking passage path may indicate that the obstacle in the picking passage path is an obstacle that cannot be removed in a short time.

As an optional implementation of this embodiment of the present disclosure, after the picking robot is controlled to move along the picking passage path, if there is an obstacle in the picking passage path that hinders the movement of the picking robot, the obstacle may be matched with a pre-stored target obstacle type. Further, if the type of the obstacle matches the target obstacle type, the preset obstacle avoidance strategy may be determined as updating the picking passage path and moving along the updated picking passage path, and the picking robot may be controlled according to this preset obstacle avoidance strategy. If the type of the obstacle does not match the target obstacle type, the preset obstacle avoidance strategy may be determined as waiting to pass until the obstacle has been removed, and the picking robot may then be controlled according to this preset obstacle avoidance strategy. The target obstacle type may be the type of an obstacle that cannot be removed in a short time. Optionally, the target obstacle type may include a no-entry sign, a shelf, etc.

According to the technical solutions of the embodiments of present disclosure, in response to receiving the plurality of picking tasks by the picking robot, the at least two candidate passage paths for the picking robot to move between the plurality of shelves in the warehouse are determined based on the plurality of picking tasks, which achieves an effect of obtaining the candidate passage paths through preliminary screening based on a plurality of picking orders. Further, the path passage efficiency corresponding to each candidate passage path is determined based on the passage influencing factor corresponding to the candidate passage path, which achieves an effect of determining the path passage efficiency based on the passage influencing factor, thus providing data support for subsequent determination of the optimal picking passage path. Then, the picking passage path is determined from the plurality of candidate passage paths based on the path passage efficiency, and the picking robot is controlled to move along the picking passage path to transport the item to be picked, which solves the problem in the related art that there is a low picking efficiency or it is difficult to stably implement high-efficiency picking by determining an optimal path using only the distance, thus achieving an effect of determining an optimal picking path on the basis of comprehensive consideration of the picking tasks and the passage influencing factor, thereby achieving an effect of ensuring high-efficiency picking by using the optimal picking path.

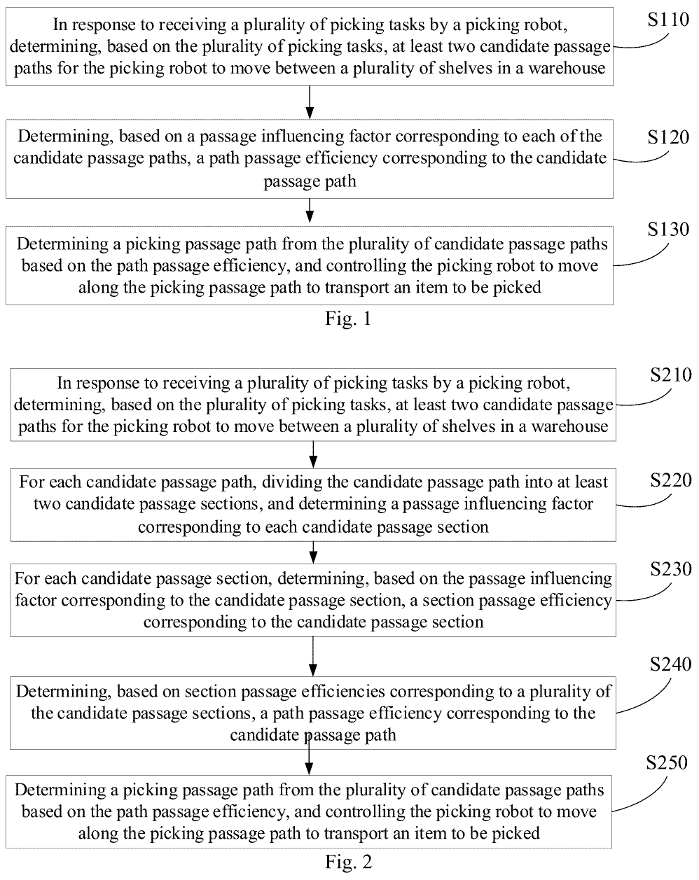

FIG. 2 is a schematic flowchart of another picking robot control method according to an embodiment of the present disclosure. On the basis of the above embodiments, the technical solution of this embodiment provides a solution for determining a path passage efficiency corresponding to a candidate passage path. Optionally, for each candidate passage path, the candidate passage path is divided into at least two candidate passage sections, and a passage influencing factor corresponding to each candidate passage section is determined. Further, for each candidate passage section, a section passage efficiency corresponding to the candidate passage section is determined based on the passage influencing factor corresponding to the candidate passage section. Then, the path passage efficiency corresponding to the candidate passage path is determined based on section passage efficiencies corresponding to a plurality of candidate passage sections. For a specific implementation, reference may be made to the description of this embodiment. Details about technical features that are the same as or similar to those in the foregoing embodiment are not repeated herein.

As shown in FIG. 2, the method in this embodiment may specifically include the following steps.

S210: In response to receiving a plurality of picking tasks by a picking robot, determining, based on the plurality of picking tasks, at least two candidate passage paths for the picking robot to move between a plurality of shelves in a warehouse.

S220: For each candidate passage path, dividing the candidate passage path into at least two candidate passage sections, and determining a passage influencing factor corresponding to each candidate passage section.

The candidate passage path may be composed of at least two candidate passage sections. For each candidate passage path, the candidate passage path may be divided into at least two candidate passage sections according to a preset section division rule. Optionally, the preset section division rule may include division based on path turning points, or division based on target picking points.

As an optional implementation of this embodiment of the present disclosure, for each candidate passage path, all the path turning points included in the candidate passage path may be determined, and a section between two adjacent path turning points may be used as one candidate passage section. Thus, the at least two candidate passage sections may be obtained.

As another optional implementation of this embodiment of the present disclosure, for each candidate passage path, a section between two adjacent target picking points in the candidate passage path may be used as one candidate passage section. Thus, the at least two candidate passage sections may be obtained.

Further, after the at least two candidate passage sections corresponding to the candidate passage path are obtained, the passage influencing factor corresponding to each candidate passage section may be determined based on road layout information, road passage information, and picker locating information in the warehouse. It should be noted that the passage influencing factor corresponding to each candidate passage section may include one or more passage influencing factors.

It should be noted that after the candidate passage path is divided into the at least two candidate passage sections, the technical solution provided in the embodiment of the present disclosure also needs to determine the passage influencing factor corresponding to each candidate passage section, where the passage influencing factor includes at least one of the road layout information in the warehouse, the road passage information in the warehouse, and a collaboration influencing factor with relative to a picker in the warehouse. During practical application, for the warehouse, the path turning points may be determined based on the road layout information, and in some cases, the road passage information may correspond to a fixed section in the warehouse. Therefore, in order to reduce the calculation amount of the section passage efficiency and improve the efficiency of determining the picking passage path, it is preferred that the candidate passage path may be divided into the at least two candidate passage sections based on the path turning points.

S230: For each candidate passage section, determining, based on the passage influencing factor corresponding to the candidate passage section, a section passage efficiency corresponding to the candidate passage section.

It should be noted that for each candidate passage section, before determination of the section passage efficiency corresponding to the candidate passage section, a section length of the candidate passage section and a corresponding average moving speed of the picking robot may be determined. Further, a ratio of the section length to the average moving speed may be determined and then used as initial section passage time corresponding to the candidate passage section.

The section passage efficiency may be a ratio of a total task volume of picking tasks covered by this section and a time taken to complete the picking tasks.

In this embodiment of the present disclosure, for each candidate passage section, the section passage efficiency corresponding to the candidate passage section may be determined based on the passage influencing factor corresponding to the candidate passage section. When the passage influencing factor corresponding to the candidate passage section includes different types of passage influencing factors, the corresponding section passage efficiency is determined in different manners. The manner for determining the section passage efficiency corresponding to each passage influencing factor is described below.

Optionally, when the passage influencing factor includes the road layout information in the warehouse, the section passage efficiency corresponding to each candidate passage section is determined based on the road layout information.

The road layout information may be information that characterizes a fixed layout preset in the warehouse. The road layout information includes a plurality of passable sections and a passage layout parameter for each passable section. The passable sections may be sections that are passable in the warehouse. The passage layout parameter may be understood as a parameter that characterizes the passage and layout condition of the section. The passage layout parameter includes at least one of section size information, a preset passage object, a preset passage speed, and a preset passage direction. The section size information may include a section length and/or a section width, etc. The preset passage object may be an object that is allowed to pass through the passable section. Optionally, the preset passage object may include the picking robot, the picker, and/or an item transport vehicle, etc. The preset passage speed may be a passage speed within a passage speed range allowed on the passable section, or may be a maximum passage speed allowed on the passable section. The preset passage direction may include one-way passage or two-way passage.

In this embodiment of the present disclosure, when the passage influencing factor includes the road layout information in the warehouse, the passage layout parameter included in the road layout information may affect the section passage efficiency of the candidate passage section. Thus, the section passage efficiency corresponding to the candidate passage section may be determined based on the passage layout parameter. Such a setting is beneficial in achieving an effect of determining the section passage efficiency of the passage section when the passage influencing factor includes the road layout information, and also achieving an effect of using the road layout information as a reference basis for determining the section passage efficiency.

Optionally, the determining, based on the road layout information, the section passage efficiency corresponding to the candidate passage section includes: determining, based on the road layout information in the warehouse, a passage layout parameter corresponding to the candidate passage section, and determining an efficiency influencing parameter corresponding to the passage layout parameter; and determining the section passage efficiency of the candidate passage section based on the passage layout parameter corresponding to the candidate passage section and the efficiency influencing parameter.

The efficiency influencing parameter may be used to indicate a degree of influence of the passage layout parameter on the passage efficiency of the candidate passage section. That is, the efficiency influencing parameter may be understood as a parameter indicating that the passage layout parameter has an influence on the passage efficiency, that is, the efficiency influencing parameter acts on the passage efficiency. In this case, a larger efficiency influencing parameter indicates a higher passage efficiency and a shorter passage time; and a smaller efficiency influencing parameter indicates a lower passage efficiency and a longer passage time. In this embodiment of the present disclosure, the efficiency influencing parameter may also be understood as a parameter indicating that the passage layout parameter has an influence on the passage time of the candidate passage section, that is, the efficiency influencing parameter acts on the passage time. In this case, a larger efficiency influencing parameter indicates a greater degree of influence of the passage layout parameter on the passage time, a longer passage time, and a lower passage efficiency; and a smaller efficiency influencing parameter indicates a smaller degree of influence of the passage layout parameter on the passage time, a shorter passage time, and a higher passage efficiency. For example, the efficiency influencing parameter being a parameter indicating that the passage layout parameter has an influence on the passage time is taken as an example. Assuming that a road width in road size information corresponding to a candidate passage section 1 is 1 meter, and a road width in road size information corresponding to a candidate passage section 2 is 2 meters, it may be shown that a degree of influence of the road size information corresponding to the candidate passage section 1 on the passage time is greater than a degree of influence of the road size information corresponding to the candidate passage section 2 on the passage time, and it can thus be determined that the efficiency influencing parameter corresponding to the candidate passage section 1 is greater than or equal to the efficiency influencing parameter corresponding to the candidate passage section 2.

In this embodiment of the present disclosure, for each passage layout parameter, a parameter value of the passage layout parameter corresponding to each passable section in the warehouse may be determined based on the road layout information in the warehouse, and the efficiency influencing parameter corresponding to each parameter value may be determined. Further, the efficiency influencing parameter may be stored in association with the passable section. Thus, an efficiency influencing parameter corresponding to the passage layout parameter for each passable section may be obtained.

As an optional implementation of this embodiment of the present disclosure, the passage layout parameter corresponding to the candidate passage section may be determined based on the road layout information in the warehouse. Further, when the passage layout parameter corresponding to the candidate passage section includes one parameter, an efficiency influencing parameter corresponding to the passage layout parameter may be determined, and the section passage efficiency corresponding to the candidate passage section may be determined based on the efficiency influencing parameter and a predetermined initial section passage time. For example, the efficiency influencing parameter being a parameter indicating that the passage layout parameter has an influence on the passage time is taken as an example. A product of the efficiency influencing parameter and the initial section passage time may be determined, and then the reciprocal of the product may be used as the section passage efficiency. Alternatively, the efficiency influencing parameter being a parameter indicating that the passage layout parameter has an influence on the passage efficiency is taken as an example. The reciprocal of the initial section passage time may be determined and then used as the initial section passage efficiency. Afterwards, a product of the efficiency influencing parameter and the initial section passage efficiency may be determined and then used as the section passage efficiency.

When the passage layout parameter corresponding to the candidate passage section includes a plurality of passage layout parameters, an efficiency influencing parameter corresponding to each passage layout parameter may be determined. Then, a product of the plurality of efficiency influencing parameters may be determined, and the section passage efficiency corresponding to the candidate passage section may be determined based on the product and a predetermined initial section passage efficiency. Such a setting is beneficial in achieving an effect of determining the efficiency influencing parameter based on the passage layout parameter for the passage section, and also achieving an effect of representing the passage influencing factor by a numerical value and thus improving the accuracy of determining the section passage efficiency.

Optionally, when the passage influencing factor includes the collaboration influencing factor with relative to the picker, the section passage efficiency of the candidate passage section is determined based on the collaboration influencing factor.

The collaboration influencing factor includes at least collaboration distance information, where the collaboration distance information is the shortest distance that a picker closest to the candidate passage section in the warehouse moves to the candidate passage section.

In this embodiment of the present disclosure, when the passage influencing factor includes the collaboration influencing factor with relative to the picker, the collaboration distance information included in the collaboration influencing factor may affect the section passage efficiency of the candidate passage section. Thus, the section passage efficiency corresponding to the candidate passage section may be determined based on the collaboration distance information. Such a setting is beneficial in achieving an effect of determining the section passage efficiency of the passage section when the passage influencing factor includes the collaboration influencing factor with relative to the picker, and also achieving an effect of using the collaboration influencing factor with relative to the picker as a reference basis for determining the section passage efficiency.

Optionally, the determining the section passage efficiency of the candidate passage section based on the collaboration influencing factor includes: determining a collaboration influencing parameter corresponding to the collaboration distance information, and determining the section passage efficiency of the candidate passage section based on the collaboration influencing parameter.

The collaboration influencing parameter is used to indicate a degree of influence of the picker on the picking efficiency. The collaboration influencing parameter may be understood as a parameter indicating that the collaboration distance information has an influence on the picking efficiency, that is, the collaboration influencing parameter acts on the picking efficiency. In this case, a larger collaboration influencing parameter indicates a higher picking efficiency and a shorter picking time; or a smaller collaboration influencing parameter indicates a lower picking efficiency and a longer picking time. In this embodiment of the present disclosure, the collaboration influencing parameter may also be understood as a parameter indicating that the collaboration distance information has an influence on the picking time, that is, the collaboration influencing parameter acts on the picking time. In this case, a larger collaboration influencing parameter indicates a longer picking time and a lower picking efficiency; or a smaller collaboration influencing parameter indicates a shorter picking time and a higher picking efficiency.

For example, the collaboration influencing parameter being a parameter indicating that the collaboration distance information has an influence on the picking time is taken as an example. Assuming that collaboration distance information corresponding to a candidate passage section 1 is 10 meters, and collaboration distance information corresponding to a candidate passage section 2 is 5 meters, a picking time corresponding to the candidate passage section 1 is greater than a picking time corresponding to the candidate passage section 2, and it can thus be determined that a collaboration influencing parameter corresponding to the candidate passage section 1 is greater than or equal to a collaboration influencing parameter corresponding to the candidate passage section 2.

In this embodiment of the present disclosure, a plurality of pieces of collaboration distance information may be preset, and a collaboration influencing parameter corresponding to each piece of collaboration distance information may be determined based on the length in the collaboration distance information. Further, the collaboration distance information may be stored in association with the corresponding collaboration influencing parameter.

As an optional implementation of this embodiment of the present disclosure, when the collaboration distance information corresponding to the candidate passage section is determined, the collaboration influencing parameter corresponding to the collaboration distance information may be determined according to a predetermined collaboration influencing association relationship. Further, the section passage efficiency corresponding to the candidate passage section may be determined based on the collaboration influencing parameter and the predetermined initial section passage time. For example, a product of the collaboration influencing parameter and the initial section passage time may be determined, and the reciprocal of the product may be used as the section passage efficiency. Such a setting is beneficial in achieving an effect of determining the collaboration influencing parameter based on the collaboration distance information, and also achieving an effect of representing the passage influencing factor by a numerical value and thus improving the accuracy of determining the section passage efficiency.

Optionally, when the passage influencing factor includes the road passage information about the candidate passage path, section passage information corresponding to the candidate passage section is determined, and a section passage efficiency corresponding to the candidate passage section is determined based on the section passage information.

The road passage information may be information that characterizes a road passage condition in the warehouse, i.e., information that characterizes real-time road conditions in the warehouse. The section passage information is information that characterizes real-time road conditions of the candidate passage section. The section passage information includes at least an object type and/or a total object number of a road passage object included in the candidate passage section within a preset time period, and the road passage object includes the picking robot and/or an item transport vehicle. For example, the item transport vehicle may be a forklift. The total object number may be the number of all the road passage objects included, that is, the total number of picking robots and/or item transport vehicles included. The preset time period may be any time period from the receipt of the picking task to expected completion of the picking task.

In this embodiment of the present disclosure, when the passage influencing factor includes the road passage information about the candidate passage path, the road passage information in the warehouse may be obtained, and the section passage information corresponding to the candidate passage section may be determined based on the road passage information. Thus, the section passage information may be analyzed to determine a road passage condition about the candidate passage section within the preset time period, and to determine a degree of influence of the road passage condition on the passage efficiency. Thus, the section passage efficiency corresponding to the candidate passage section may be determined. Such a setting is beneficial in achieving an effect of determining the section passage efficiency of the passage section when the passage influencing factor includes the road passage information about the candidate passage path, and also achieving an effect of using the road passage information as a reference basis for determining the section passage efficiency.

In this embodiment of the present disclosure, when the section passage information corresponding to the candidate passage section indicates that the road passage object included in the candidate passage section within the preset time period is only the picking robot, the candidate passage section corresponds to a higher section passage efficiency; or when the section passage information corresponding to the candidate passage section indicates that the road passage object included in the candidate passage section within the preset time period is a picking machine and the item transport vehicle, the candidate passage section corresponds to a lower section passage efficiency. A greater total number of road passage objects included in the candidate passage section within the preset time period in the section passage information corresponding to the candidate passage section indicates that the candidate passage section corresponds to a lower section passage efficiency.

As an optional implementation of this embodiment of the present disclosure, a passage influencing parameter corresponding to the section passage information is determined, and the section passage efficiency of the candidate passage section is determined based on the passage influencing parameter. The passage influencing parameter characterizes a degree of influence of the section passage information corresponding to the candidate passage section on the passage efficiency. The passage influencing parameter may be understood as a parameter indicating that the section passage information has an influence on the passage efficiency, that is, the passage influencing parameter acts on the passage efficiency. In this case, a larger passage influencing parameter indicates a higher passage efficiency and a shorter passage time; or a smaller passage influencing parameter indicates a lower passage efficiency and a longer passage time. In this embodiment of the present disclosure, the passage influencing parameter may also be understood as a parameter indicating that the section passage information has an influence on the passage time of the candidate passage section, that is, the passage influencing parameter acts on the passage time. In this case, a larger passage influencing parameter indicates a greater degree of influence of the section passage information on the passage time, a longer passage time, and a lower passage efficiency; or a smaller passage influencing parameter indicates a smaller degree of influence of the section passage information on the passage time, a shorter passage time, and a higher passage efficiency.

For example, the passage influencing parameter being a parameter indicating that the section passage information has an influence on the passage time is taken as an example for description. It is assumed that object types of road passage objects included in section passage information corresponding to the candidate passage section 1 are a picking robot and a forklift, and there is a total number of 5 objects; and an object type of a road passage object included in section passage information corresponding to the candidate passage section 2 is a picking robot, and there is a total number of 1 object. Then, it may be determined that a degree of influence of the section passage information corresponding to the candidate passage section 1 on the passage time is greater than a degree of influence of the section passage information corresponding to the candidate passage section 2 on the passage efficiency, and it may thus be determined that a passage influencing parameter corresponding to the candidate passage section 1 is greater than a passage influencing parameter corresponding to the candidate passage section 2.

S240: Determining, based on section passage efficiencies corresponding to a plurality of the candidate passage sections, a path passage efficiency corresponding to the candidate passage path.

In this embodiment of the present disclosure, after the section passage efficiency corresponding to each candidate passage section is obtained, the path passage efficiency corresponding to the candidate passage path may be determined based on the plurality of section passage efficiencies.

As an optional implementation of this embodiment of the present disclosure, the plurality of section passage efficiencies may be added to determine a sum of the section passage efficiencies. Then, the determined efficiency sum may be used as the path passage efficiency corresponding to the candidate passage path.

S250: Determining a picking passage path from the plurality of candidate passage paths based on the path passage efficiency, and controlling the picking robot to move along the picking passage path to transport an item to be picked.

According to the technical solutions in the embodiments of present disclosure, when the picking robot receives the plurality of picking tasks, the at least two candidate passage paths for the picking robot to move between the plurality of shelves in the warehouse are determined based on the plurality of picking tasks. Further, for each candidate passage path, the candidate passage path is divided into at least two candidate passage sections, and the passage influencing factor corresponding to each candidate passage section is determined. Next, for each candidate passage section, the section passage efficiency corresponding to the candidate passage section is determined based on the passage influencing factor corresponding to the candidate passage section. Then, the path passage efficiency corresponding to the candidate passage path is determined based on the section passage efficiencies corresponding to the plurality of candidate passage sections. Finally, the picking passage path is determined from the plurality of candidate passage paths based on the path passage efficiency, and the picking robot is controlled to move along the picking passage path to transport the item to be picked. Therefore, an effect of dividing the path into the plurality of sections, determining the section passage efficiency, and determining the path passage efficiency based on the section passage efficiency is achieved, the accuracy of determining the path passage efficiency is improved, and thus an effect of ensuring high-efficiency picking by using an optimal passage path is achieved.

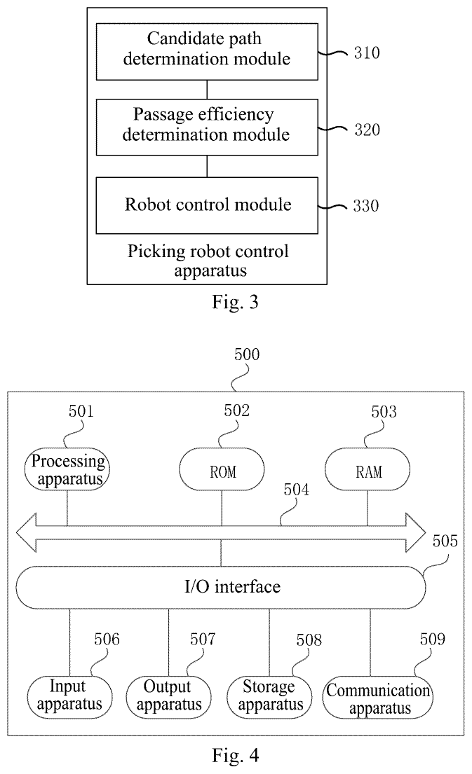

FIG. 3 is a schematic diagram of a structure of a picking robot control apparatus according to an embodiment of the present disclosure. As shown in FIG. 3, the apparatus includes: a candidate path determination module 310, a passage efficiency determination module 320, and a robot control module 330.

The candidate path determination module 310 is configured to, in response to receiving a plurality of picking tasks by a picking robot, determine, based on the plurality of picking tasks, at least two candidate passage paths for the picking robot to move between a plurality of shelves in a warehouse. The passage efficiency determination module 320 is configured to determine, based on a passage influencing factor corresponding to each of the candidate passage paths, a path passage efficiency corresponding to the candidate passage path, where the passage influencing factor includes at least one of road layout information in the warehouse, road passage information in the warehouse, and a collaboration influencing factor with relative to a picker in the warehouse. The robot control module 330 is configured to determine a picking passage path from a plurality of candidate passage paths based on the path passage efficiency, and control the picking robot to move along the picking passage path to transport an item to be picked.

On the basis of the above optional technical solutions, optionally, the passage efficiency determination module 320 includes: an influencing factor determination submodule, a section passage efficiency determination submodule, and a path passage efficiency determination submodule.

The influencing factor determination submodule is configured to, for each of the candidate passage paths, divide the candidate passage path into at least two candidate passage sections, and determine a passage influencing factor corresponding to each of the candidate passage sections.

The section passage efficiency determination submodule is configured to, for each of the candidate passage sections, determine, based on the passage influencing factor corresponding to the candidate passage section, a section passage efficiency corresponding to the candidate passage section.

The path passage efficiency determination submodule is configured to determine, based on section passage efficiencies corresponding to a plurality of the candidate passage sections, the path passage efficiency corresponding to the candidate passage path.

On the basis of the above optional technical solutions, optionally, the section passage efficiency determination submodule includes: a first section passage efficiency determination unit.

The first section passage efficiency determination unit is configured to, when the passage influencing factor includes the road layout information in the warehouse, determine, based on the road layout information, the section passage efficiency corresponding to the candidate passage section, where the road layout information includes a plurality of passable sections and a passage layout parameter for each of the passable sections, and the passage layout parameter includes at least one of section size information, a preset passage object, a preset passage speed, and a preset passage direction.

On the basis of the above optional technical solutions, optionally, the first section passage efficiency determination unit includes: an influencing parameter determination subunit and a passage efficiency determination subunit.

The influencing parameter determination subunit is configured to determine, based on the road layout information in the warehouse, a passage layout parameter corresponding to the candidate passage section, and determine an efficiency influencing parameter corresponding to the passage layout parameter, where the efficiency influencing parameter is used to indicate a degree of influence of the passage layout parameter on the passage efficiency of the candidate passage section.

The passage efficiency determination subunit is configured to determine a section passage efficiency of the candidate passage section based on the passage layout parameter corresponding to the candidate passage section and the efficiency influencing parameter.

On the basis of the above optional technical solutions, optionally, the section passage efficiency determination submodule includes: a second section passage efficiency determination unit.

The second section passage efficiency determination unit is configured to, when the passage influencing factor includes the collaboration influencing factor with relative to the picker, determine the section passage efficiency of the candidate passage section based on the collaboration influencing factor, where the collaboration influencing factor includes at least collaboration distance information, and the collaboration distance information is the shortest distance that a picker closest to the candidate passage section in the warehouse moves to the candidate passage section.

On the basis of the above optional technical solutions, optionally, the second section passage efficiency determination unit is specifically configured to determine a collaboration influencing parameter corresponding to the collaboration distance information, and determine the section passage efficiency of the candidate passage section based on the collaboration influencing parameter, where the collaboration influencing parameter is used to indicate a degree of influence of the picker on a picking efficiency.

On the basis of the above optional technical solutions, optionally, the section passage efficiency determination submodule includes: a third section passage efficiency determination unit.

The third section passage efficiency determination unit is configured to, when the passage influencing factor includes the road passage information about the candidate passage path, determine section passage information corresponding to the candidate passage section, and determine, based on the section passage information, the section passage efficiency corresponding to the candidate passage section, where the section passage information includes at least an object type and/or a total object number of a road passage object included in the candidate passage section within a preset time period, and the road passage object includes the picking robot and/or an item transport vehicle.

On the basis of the above optional technical solutions, optionally, the candidate path determination module 310 includes: an initial path determination unit and a candidate path determination unit.

The initial path determination unit is configured to determine a plurality of target picking points corresponding to the plurality of picking tasks, and determine a plurality of initial passage paths based on the plurality of target picking points and the road layout information in the warehouse.

The candidate path determination unit is configured to determine the at least two candidate passage paths from the plurality of initial passage paths according to a descending sort of lengths of the initial passage paths.

On the basis of the above optional technical solutions, optionally, after the picking robot is controlled to move along the picking passage path, the apparatus further includes: a robot obstacle avoidance control module.

The robot obstacle avoidance control module is configured to, when there is an obstacle in the picking passage path that hinders the movement of the picking robot after the picking robot is controlled to move along the picking passage path, control the picking robot according to a preset obstacle avoidance strategy, where the preset obstacle avoidance strategy includes waiting to pass until the obstacle has been removed, or updating the picking passage path and moving along the updated picking passage path.

According to the technical solutions of the embodiments of present disclosure, in response to receiving the plurality of picking tasks by the picking robot, the at least two candidate passage paths for the picking robot to move between the plurality of shelves in the warehouse are determined based on the plurality of picking tasks, which achieves an effect of obtaining the candidate passage paths through preliminary screening based on a plurality of picking orders. Further, the path passage efficiency corresponding to each candidate passage path is determined based on the passage influencing factor corresponding to the candidate passage path, which achieves an effect of determining the path passage efficiency based on the passage influencing factor, thus providing data support for subsequent determination of the optimal picking passage path. Afterwards, the picking passage path is determined from a plurality of the candidate passage paths based on the path passage efficiency, and the picking robot is controlled to move along the picking passage path to transport the item to be picked, which solves the problem in the related art that there is a low picking efficiency or it is difficult to stably implement high-efficiency picking by determining an optimal path using only the distance, thus achieving an effect of determining an optimal picking path on the basis of comprehensive consideration of the picking tasks and the passage influencing factor, thereby achieving an effect of ensuring high-efficiency picking by using the optimal picking path.

The picking robot control apparatus according to the embodiments of the present disclosure can perform the picking robot control method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, the specific names of the functional units are only used for the convenience of distinguishing each other, and are not intended to limit the scope of protection of the embodiments of the present disclosure.

FIG. 4 is a schematic diagram of a structure of an electronic device according to an embodiment of the present disclosure. Reference is made to FIG. 4 below, which is a schematic diagram of a structure of an electronic device (such as a terminal device or a server in FIG. 4) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 4 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the picking robot control method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the picking robot control method according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hyper Text Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: in response to receiving a plurality of picking tasks by a picking robot, determine, based on the plurality of picking tasks, at least two candidate passage paths for the picking robot to move between a plurality of shelves in a warehouse; determine, based on a passage influencing factor corresponding to each of the candidate passage paths, a path passage efficiency corresponding to the candidate passage path, where the passage influencing factor includes at least one of road layout information in the warehouse, road passage information in the warehouse, and a collaboration influencing factor with relative to a picker in the warehouse; and determine a picking passage path from a plurality of the candidate passage paths based on the path passage efficiency, and control the picking robot to move along the picking passage path to transport an item to be picked.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a picking robot control method. The method includes:
in response to receiving a plurality of picking tasks by a picking robot, determining, based on the plurality of picking tasks, at least two candidate passage paths for the picking robot to move between a plurality of shelves in a warehouse;
determining, based on a passage influencing factor corresponding to each of the candidate passage paths, a path passage efficiency corresponding to the candidate passage path, where the passage influencing factor includes at least one of road layout information in the warehouse, road passage information in the warehouse, and a collaboration influencing factor with relative to a picker in the warehouse; and
determining a picking passage path from a plurality of the candidate passage paths based on the path passage efficiency, and controlling the picking robot to move along the picking passage path to transport an item to be picked.

According to one or more embodiments of the present disclosure, [Example 2] provides the method of Example 1, where
optionally, the determining, based on a passage influencing factor corresponding to each of the candidate passage paths, a path passage efficiency corresponding to the candidate passage path includes: for each of the candidate passage paths, dividing the candidate passage path into at least two candidate passage sections, and determining a passage influencing factor corresponding to each of the candidate passage sections; for each of the candidate passage sections, determining, based on the passage influencing factor corresponding to the candidate passage section, a section passage efficiency corresponding to the candidate passage section; and determining, based on section passage efficiencies corresponding to a plurality of the candidate passage sections, the path passage efficiency corresponding to the candidate passage path.

According to one or more embodiments of the present disclosure, [Example 3] provides the method of Example 2, where
optionally, the determining, based on the passage influencing factor corresponding to the candidate passage section, a section passage efficiency corresponding to the candidate passage section includes: when the passage influencing factor includes the road layout information in the warehouse, determining, based on the road layout information, the section passage efficiency corresponding to the candidate passage section, where the road layout information includes a plurality of passable sections and a passage layout parameter for each of the passable sections, and the passage layout parameter includes at least one of section size information, a preset passage object, a preset passage speed, and a preset passage direction.

According to one or more embodiments of the present disclosure, [Example 4] provides the method of Example 3, where
optionally, the determining, based on the road layout information, the section passage efficiency corresponding to each of the candidate passage sections includes: determining, based on the road layout information in the warehouse, a passage layout parameter corresponding to the candidate passage section, and determining an efficiency influencing parameter corresponding to the passage layout parameter, where the efficiency influencing parameter is used to indicate a degree of influence of the passage layout parameter on the passage efficiency of the candidate passage section; and determining the section passage efficiency of the candidate passage section based on the passage layout parameter corresponding to the candidate passage section and the efficiency influencing parameter.

According to one or more embodiments of the present disclosure, [Example 5] provides the method of Example 2, where
optionally, the determining, based on the passage influencing factor corresponding to the candidate passage section, a section passage efficiency corresponding to each of the candidate passage sections includes: when the passage influencing factor includes the collaboration influencing factor with relative to the picker, determining the section passage efficiency of the candidate passage section based on the collaboration influencing factor, where the collaboration influencing factor includes at least collaboration distance information, and the collaboration distance information is the shortest distance that a picker closest to the candidate passage section in the warehouse moves to the candidate passage section.

According to one or more embodiments of the present disclosure, [Example 6] provides the method of Example 5, where
optionally, the determining the section passage efficiency of the candidate passage section based on the collaboration influencing factor includes: determining a collaboration influencing parameter corresponding to the collaboration distance information, and determining the section passage efficiency of the candidate passage section based on the collaboration influencing parameter, where the collaboration influencing parameter is used to indicate a degree of influence of the picker on a picking efficiency.

According to one or more embodiments of the present disclosure, [Example 7] provides the method of Example 2, where
optionally, the determining, based on the passage influencing factor corresponding to the candidate passage section, a section passage efficiency corresponding to the candidate passage section includes: when the passage influencing factor includes the road passage information about the candidate passage path, determining section passage information corresponding to the candidate passage section, and determining, based on the section passage information, the section passage efficiency corresponding to the candidate passage section, where the section passage information includes at least an object type and/or a total object number of a road passage object included in the candidate passage section within a preset time period, and the road passage object includes the picking robot and/or an item transport vehicle.

According to one or more embodiments of the present disclosure, [Example 8] provides the method of Example 1, where
optionally, the determining, based on the plurality of picking tasks, at least two candidate passage paths for the picking robot to move between a plurality of shelves in a warehouse includes: determining a plurality of target picking points corresponding to the plurality of picking tasks, and determining a plurality of initial passage paths based on the plurality of target picking points and the road layout information in the warehouse; and determining the at least two candidate passage paths from the plurality of initial passage paths according to an ascending sort of lengths of the initial passage paths.

According to one or more embodiments of the present disclosure, [Example 9] provides the method of Example 1, where
optionally, after the controlling the picking robot to move along the picking passage path, the method further includes: when there is an obstacle in the picking passage path that hinders the movement of the picking robot, controlling the picking robot according to a preset obstacle avoidance strategy, where the preset obstacle avoidance strategy includes waiting to pass until the obstacle has been removed, or updating the picking passage path and moving along the updated picking passage path.

According to one or more embodiments of the present disclosure, [Example 10] provides a picking robot control apparatus. The apparatus includes:
a candidate path determination module, configured to, in response to receiving a plurality of picking tasks by a picking robot, determine, based on the plurality of picking tasks, at least two candidate passage paths for the picking robot to move between a plurality of shelves in a warehouse;
a passage efficiency determination module, configured to determine, based on a passage influencing factor corresponding to each of the candidate passage paths, a path passage efficiency corresponding to the candidate passage path, where the passage influencing factor includes at least one of road layout information in the warehouse, road passage information in the warehouse, and a collaboration influencing factor with relative to a picker in the warehouse; and
a robot control module, configured to determine a picking passage path from a plurality of the candidate passage paths based on the path passage efficiency, and control the picking robot to move along the picking passage path to transport an item to be picked.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A picking robot control method, comprising:
in response to receiving a plurality of picking tasks by a picking robot, determining, based on the plurality of picking tasks, at least two candidate passage paths for the picking robot to move between a plurality of shelves in a warehouse;
determining, based on a passage influencing factor corresponding to each of the candidate passage paths, a path passage efficiency corresponding to the candidate passage path, wherein the passage influencing factor comprises at least one of road layout information in the warehouse, road passage information in the warehouse, and a collaboration influencing factor with relative to a picker in the warehouse; and
determining a picking passage path from a plurality of the candidate passage paths based on the path passage efficiency, and controlling the picking robot to move along the picking passage path to transport an item to be picked.

2. The picking robot control method according to claim 1, wherein the determining, based on a passage influencing factor corresponding to each of the candidate passage paths, a path passage efficiency corresponding to the candidate passage path comprises:
for each of the candidate passage paths, dividing the candidate passage path into at least two candidate passage sections, and determining a passage influencing factor corresponding to each of the candidate passage sections;
for each of the candidate passage sections, determining, based on the passage influencing factor corresponding to the candidate passage section, a section passage efficiency corresponding to the candidate passage section; and
determining, based on section passage efficiencies corresponding to a plurality of the candidate passage sections, the path passage efficiency corresponding to the candidate passage path.

3. The picking robot control method according to claim 2, wherein the determining, based on the passage influencing factor corresponding to the candidate passage section, a section passage efficiency corresponding to the candidate passage section comprises:
in response to the passage influencing factor comprising the road layout information in the warehouse, determining, based on the road layout information, the section passage efficiency corresponding to the candidate passage section, wherein the road layout information comprises a plurality of passable sections and a passage layout parameter for each of the passable sections, and the passage layout parameter comprises at least one of section size information, a preset passage object, a preset passage speed, and a preset passage direction.

4. The picking robot control method according to claim 3, wherein the determining, based on the road layout information, the section passage efficiency corresponding to the candidate passage section comprises:
determining, based on the road layout information in the warehouse, a passage layout parameter corresponding to the candidate passage section, and determining an efficiency influencing parameter corresponding to the passage layout parameter, wherein the efficiency influencing parameter is used to indicate a degree of influence of the passage layout parameter on the section passage efficiency of the candidate passage section; and
determining the section passage efficiency of the candidate passage section based on the passage layout parameter corresponding to the candidate passage section and the efficiency influencing parameter.

5. The picking robot control method according to claim 2, wherein the determining, based on the passage influencing factor corresponding to the candidate passage section, a section passage efficiency corresponding to the candidate passage section comprises:
in response to the passage influencing factor comprising the collaboration influencing factor with relative to the picker, determining the section passage efficiency of the candidate passage section based on the collaboration influencing factor, wherein the collaboration influencing factor comprises at least collaboration distance information, and the collaboration distance information is a shortest distance that a picker closest to the candidate passage section in the warehouse moves to the candidate passage section.

6. The picking robot control method according to claim 5, wherein the determining the section passage efficiency of the candidate passage section based on the collaboration influencing factor comprises:
determining a collaboration influencing parameter corresponding to the collaboration distance information, and determining the section passage efficiency of the candidate passage section based on the collaboration influencing parameter, wherein the collaboration influencing parameter is used to indicate a degree of influence of the picker on a picking efficiency.

7. The picking robot control method according to claim 2, wherein the determining, based on the passage influencing factor corresponding to the candidate passage section, a section passage efficiency corresponding to the candidate passage section comprises:
in response to the passage influencing factor comprising the road passage information about the candidate passage path, determining section passage information corresponding to the candidate passage section, and determining, based on the section passage information, the section passage efficiency corresponding to the candidate passage section, wherein the section passage information comprises at least an object type and/or a total object number of a road passage object comprised in the candidate passage section within a preset time period, and the road passage object comprises the picking robot and/or an item transport vehicle.

8. The picking robot control method according to claim 1, wherein the determining, based on the plurality of picking tasks, at least two candidate passage paths for the picking robot to move between a plurality of shelves in a warehouse comprises:
determining a plurality of target picking points corresponding to the plurality of picking tasks, and determining a plurality of initial passage paths based on the plurality of target picking points and the road layout information in the warehouse; and
determining the at least two candidate passage paths from the plurality of initial passage paths according to an ascending sort of lengths of the initial passage paths.

9. The picking robot control method according to claim 1, wherein after the controlling the picking robot to move along the picking passage path, the method further comprises:
in response to an obstacle being existed in the picking passage path that hinders a movement of the picking robot, controlling the picking robot according to a preset obstacle avoidance strategy, wherein the preset obstacle avoidance strategy comprises waiting to pass until the obstacle has been removed, or updating the picking passage path and moving along the updated picking passage path.

10. An electronic device, comprising:
one or more processors; and
a storage apparatus configured to store one or more programs, wherein
the one or more programs, when executed by the one or more processors, cause the one or more processors to implement a picking robot control method, comprising:
in response to receiving a plurality of picking tasks by a picking robot, determining, based on the plurality of picking tasks, at least two candidate passage paths for the picking robot to move between a plurality of shelves in a warehouse;
determining, based on a passage influencing factor corresponding to each of the candidate passage paths, a path passage efficiency corresponding to the candidate passage path, wherein the passage influencing factor comprises at least one of road layout information in the warehouse, road passage information in the warehouse, and a collaboration influencing factor with relative to a picker in the warehouse; and
determining a picking passage path from a plurality of the candidate passage paths based on the path passage efficiency, and controlling the picking robot to move along the picking passage path to transport an item to be picked.

11. The electronic device according to claim 10, wherein in the picking robot control method, the determining, based on a passage influencing factor corresponding to each of the candidate passage paths, a path passage efficiency corresponding to the candidate passage path comprises:
for each of the candidate passage paths, dividing the candidate passage path into at least two candidate passage sections, and determining a passage influencing factor corresponding to each of the candidate passage sections;
for each of the candidate passage sections, determining, based on the passage influencing factor corresponding to the candidate passage section, a section passage efficiency corresponding to the candidate passage section; and
determining, based on section passage efficiencies corresponding to a plurality of the candidate passage sections, the path passage efficiency corresponding to the candidate passage path.

12. The electronic device according to claim 11, wherein in the picking robot control method,
the determining, based on the passage influencing factor corresponding to the candidate passage section, a section passage efficiency corresponding to the candidate passage section comprises:
in response to the passage influencing factor comprising the road layout information in the warehouse, determining, based on the road layout information, the section passage efficiency corresponding to the candidate passage section, wherein the road layout information comprises a plurality of passable sections and a passage layout parameter for each of the passable sections, and the passage layout parameter comprises at least one of section size information, a preset passage object, a preset passage speed, and a preset passage direction.

13. The electronic device according to claim 12, wherein in the picking robot control method,
the determining, based on the road layout information, the section passage efficiency corresponding to the candidate passage section comprises:
determining, based on the road layout information in the warehouse, a passage layout parameter corresponding to the candidate passage section, and determining an efficiency influencing parameter corresponding to the passage layout parameter, wherein the efficiency influencing parameter is used to indicate a degree of influence of the passage layout parameter on the section passage efficiency of the candidate passage section; and
determining the section passage efficiency of the candidate passage section based on the passage layout parameter corresponding to the candidate passage section and the efficiency influencing parameter.

14. The electronic device according to claim 11, wherein in the picking robot control method,
the determining, based on the passage influencing factor corresponding to the candidate passage section, a section passage efficiency corresponding to the candidate passage section comprises:
in response to the passage influencing factor comprising the collaboration influencing factor with relative to the picker, determining the section passage efficiency of the candidate passage section based on the collaboration influencing factor, wherein the collaboration influencing factor comprises at least collaboration distance information, and the collaboration distance information is a shortest distance that a picker closest to the candidate passage section in the warehouse moves to the candidate passage section.

15. The electronic device according to claim 14, wherein in the picking robot control method,
the determining the section passage efficiency of the candidate passage section based on the collaboration influencing factor comprises:
determining a collaboration influencing parameter corresponding to the collaboration distance information, and determining the section passage efficiency of the candidate passage section based on the collaboration influencing parameter, wherein the collaboration influencing parameter is used to indicate a degree of influence of the picker on a picking efficiency.

16. The electronic device according to claim 11, wherein in the picking robot control method,
the determining, based on the passage influencing factor corresponding to the candidate passage section, a section passage efficiency corresponding to the candidate passage section comprises:
in response to the passage influencing factor comprising the road passage information about the candidate passage path, determining section passage information corresponding to the candidate passage section, and determining, based on the section passage information, the section passage efficiency corresponding to the candidate passage section, wherein the section passage information comprises at least an object type and/or a total object number of a road passage object comprised in the candidate passage section within a preset time period, and the road passage object comprises the picking robot and/or an item transport vehicle.

17. The electronic device according to claim 10, wherein in the picking robot control method,
the determining, based on the plurality of picking tasks, at least two candidate passage paths for the picking robot to move between a plurality of shelves in a warehouse comprises:
determining a plurality of target picking points corresponding to the plurality of picking tasks, and determining a plurality of initial passage paths based on the plurality of target picking points and the road layout information in the warehouse; and
determining the at least two candidate passage paths from the plurality of initial passage paths according to an ascending sort of lengths of the initial passage paths.

18. The electronic device according to claim 10, wherein in the picking robot control method,
after the controlling the picking robot to move along the picking passage path, further comprising:
in response to an obstacle being existed in the picking passage path that hinders a movement of the picking robot, controlling the picking robot according to a preset obstacle avoidance strategy, wherein the preset obstacle avoidance strategy comprises waiting to pass until the obstacle has been removed, or updating the picking passage path and moving along the updated picking passage path.

19. A non-transient computer-readable storage medium, comprising computer-executable instructions, wherein the computer-executable instructions, when executed by a computer processor, are configured to perform a picking robot control method, comprising:
in response to receiving a plurality of picking tasks by a picking robot, determining, based on the plurality of picking tasks, at least two candidate passage paths for the picking robot to move between a plurality of shelves in a warehouse;
determining, based on a passage influencing factor corresponding to each of the candidate passage paths, a path passage efficiency corresponding to the candidate passage path, wherein the passage influencing factor comprises at least one of road layout information in the warehouse, road passage information in the warehouse, and a collaboration influencing factor with relative to a picker in the warehouse; and
determining a picking passage path from a plurality of the candidate passage paths based on the path passage efficiency, and controlling the picking robot to move along the picking passage path to transport an item to be picked.
